(19) United States
(12) Patent Application Publication
(10) Pub. No.: US 2010/0208075 A1
(43) Pub. Date: Aug. 19, 2010

(54) SURROUNDINGS MONITORING DEVICE FOR VEHICLE

(75) Inventor: Toshiyasu KATSUNO, Nagoya-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi (JP)

(21) Appl. No.: 12/705,179

(22) Filed: Feb. 12, 2010

(30) Foreign Application Priority Data
Feb. 16, 2009 (JP) 2009-032682

(51) Int. Cl. H04N 7/18

(52) U.S. Cl. 348/148; 348/E07.085

(57) ABSTRACT

A surroundings monitoring device for a vehicle, including: an image acquisition unit that acquires an image of vehicle surroundings; an obstacle recognition unit that recognizes an obstacle in the image acquired by the image acquisition unit, calculates a position of the obstacle, and calculates a detection reliability indicating accuracy of recognition of the obstacle; a risk degree calculation unit that calculates a risk degree that indicates a degree of risk of a collision between the obstacle and the vehicle; and an attention drawing unit that outputs an attention drawing signal for drawing a driver's attention on the basis of the detection reliability and the risk degree.

### INCORPORATION BY REFERENCE

The disclosure of Japanese Patent Application No. 2009-032682 filed on Feb. 16, 2009 including the specification, drawings and abstract is incorporated herein by reference in its entirety.

### BACKGROUND OF THE INVENTION

1. Field of the Invention

The invention relates to a surroundings monitoring device for a vehicle that acquires an image of vehicle surroundings and outputs an signal for drawing a driver's attention on the basis of the acquired image.

2. Description of the Related Art

A surroundings monitoring device for a vehicle has been suggested in which an image acquisition unit such as a camera is installed on the vehicle, an image of the vehicle surroundings that has been acquired by the image acquisition unit such as a camera is displayed on a display provided in a position inside the vehicle where the display can be viewed by the driver, and the displayed images enhance a view field of the driver.

For example, Japanese Patent Application Publication No. 2007-087203 (JP-A-2007-087203), Japanese Patent Application Publication No. 2008-027309 (JP-A-2008-027309), and Japanese Patent Application Publication No. 2008-135856 (JP-A-2008-135856) disclose such surroundings monitoring devices for a vehicle in which an images of vehicle surroundings is acquired, the presence of an obstacle such as a pedestrian is recognized based on the acquired image, and the presence of the obstacle is displayed to draw the driver's attention. The driver may look at the display as a result of drawing the driver's attention to the presence of the obstacle by means of display.

Therefore, when the driver is drawn his attention to look at the display each time an obstacle such as a pedestrian is present, the driver's attention may be distracted from the zone forward of the vehicle.

In a case where a risk of the vehicle colliding with the obstacle is low, for example, when the distance between the vehicle and the obstacle is sufficiently large, it is preferred that the driver looks directly forward of the vehicle for maintaining the driver's attention to the zone forward of the vehicle, rather than looks at the display by being drawn his attention.

Also, there is a variation in detection reliability (accuracy of detection) of obstacles such as pedestrians. When the detection reliability is low, it is also preferred that the driver looks directly forward of the vehicle without looking at the display by being drawn his attention, for maintaining the driver's attention to the zone forward of the vehicle.

On the other hand, where a risk of the vehicle colliding with an obstacle is high and the detection reliability of the obstacle is high, a high probability of danger can be assumed. Therefore, it is necessary to draw the driver's attention with higher reliability to enable a danger avoiding maneuver.

However, in the conventional surroundings monitoring devices for vehicles. cases as described hereinabove are not adequately distinguished. Thus, the presence of the obstacle is displayed to draw the driver's attention and to make the driver look at the display, even when the necessity of drawing the attention is low. As a result, the driver's attention to the zone forward of the vehicle may not be maintained.

### SUMMARY OF THE INVENTION

The invention provides a surroundings monitoring device for a vehicle that can draw the driver's attention, as necessary, with consideration for and a degree of risk of the vehicle colliding with an obstacle and an obstacle detection reliability.

A surroundings monitoring device for a vehicle according to the first aspect of the invention includes: an image acquisition unit that acquires an image of vehicle surroundings; an obstacle recognition unit that recognizes an obstacle in the image acquired by the image acquisition unit, calculates a position of the obstacle, and calculates a detection reliability indicating accuracy of recognition of the obstacle; a risk degree calculation unit that calculates a risk degree that indicates a degree of risk of a collision between the obstacle and the vehicle; and an attention drawing unit that outputs an attention drawing signal for drawing a driver's attention on the basis of the detection reliability and the risk degree.

According to the first aspect of the invention, it is possible to provide a surroundings monitoring device for a vehicle that can draw the driver's attention, as necessary, with consideration for a degree of risk of the vehicle colliding with an obstacle and an obstacle detection reliability.

### BRIEF DESCRIPTION OF THE DRAWINGS

The foregoing and further objects, features and advantages of the invention will become apparent from the following description of example embodiments with reference to the accompanying drawings, wherein like numerals denote like elements, and wherein:

FIG. 1 illustrates an example of a schematic configuration of the surroundings monitoring device for a vehicle according to the present embodiment;

FIG. 2 illustrates an estimated risk degree calculation means (variant 1) according to the present embodiment;

FIG. 3 illustrates an estimated risk degree calculation means (variant 2) according to the present embodiment;

FIG. 4 illustrates a risk degree calculation means according to the present embodiment;

FIG. 5 illustrates a detection reliability correction value calculation means according to the present embodiment;

FIGS. 6A to 6C shows an example of the image displayed at the display unit of the present embodiment; and

FIG. 7 is an example of the flowchart of operations performed by the surroundings monitoring device for a vehicle of the present embodiment.

### DETAILED DESCRIPTION OF EMBODIMENTS

An embodiment of the invention will be described below with reference to the accompanying drawings.

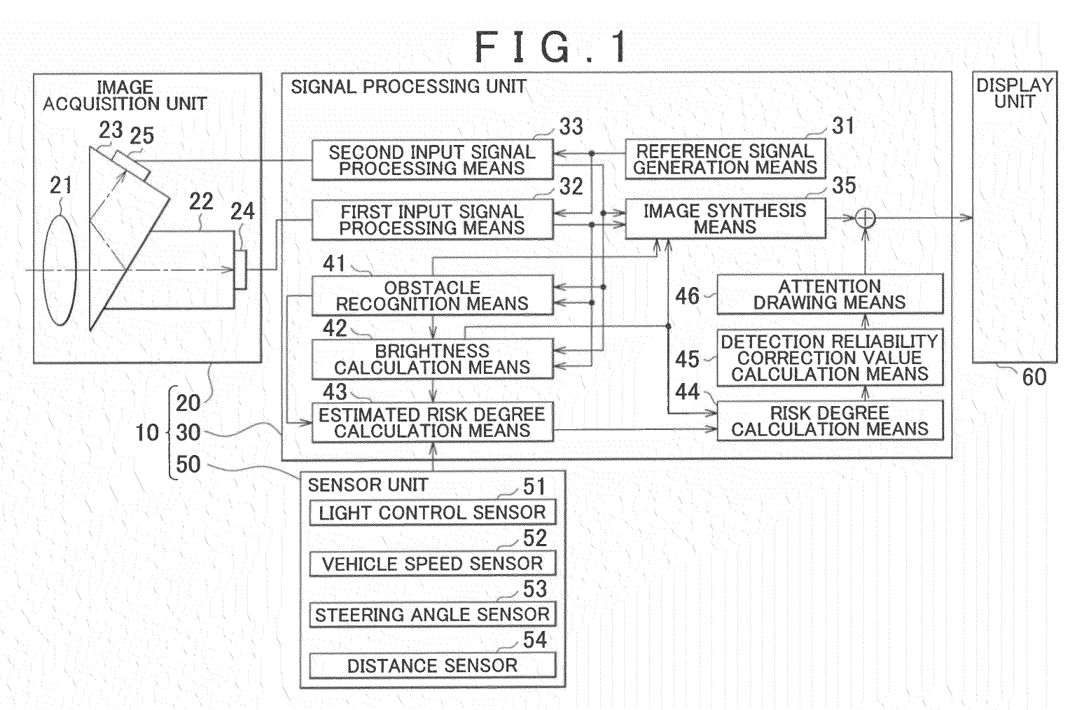

FIG. 1 illustrates an example of a schematic configuration of the surroundings monitoring device for a vehicle according to the present embodiment. As shown in FIG. 1, the surroundings monitoring device 10 for a vehicle has an image acquisition unit 20, a signal processing unit 30, and a sensor unit 50. A display unit 60 displays image signals outputted from the surroundings monitoring device 10 for a vehicle.

The image acquisition unit 20 has a lens 21, a first prism 22, a second prism 22, a first image pickup element 24, and a second image pickup element 25. The signal processing unit 30 has a reference signal generation means 31, a first input signal processing means 32, a second input signal processing means 33, an image synthesis means 35, an obstacle recognition means 41, a brightness calculation means 42, an estimated risk degree calculation means 43, a risk degree calculation means 44, a detection reliability correction value calculation means 45, an attention drawing means 46, and a central processing unit (CPU), a storage unit (memory), and the like that are not shown in the figure. The sensor unit 50 has a light control sensor 51, a vehicle speed sensor 52, a steering angle sensor 53, and a distance sensor 54.

The image acquisition unit 20 is, for example, a Charge Coupled Device (CCD) camera or a Complementary Metal-Oxide Semiconductor (CMOS) camera. The image acquisition unit 20 has a function of acquiring an image of vehicle surroundings. The lens 21 is, for example, a fish-eye lens. The lens 21 has a function of collecting the light emitted from the object into an image.

The first prism 22 and the second prism 23 are constituted, for example, by glass or quartz. The first prism 22 and the second prism 23 have a function of transmitting linearly the light of a first wavelength region from among the incident light from the lens 21, and selectively introducing the transmitted light in the first image pickup element 24. Further, the first prism 22 and the second prism 23 also have a function of reflecting the light of the second wavelength region that has a wavelength longer than that of the light of the first wavelength region, from among the incident light from the lens 21, by a boundary surface of the first prism 22 and the second prism 23, and selectively introducing the reflected light in the second image pickup element 25.

In this case, the first wavelength region is a wavelength region including a visible light region, and the second wavelength region is a wavelength region including a near-infrared region. The first wavelength region may be, for example, only the visible light region or a wavelength region obtained by adding the near-infrared region to the visible light region. Further, the second wavelength region may be, for example, only the near-infrared region or a wavelength region obtained by adding an infrared region to the near-infrared region.

The first image pickup element 24 and the second image pickup element 25 are constituted, for example, by a semiconductor such as CCD or CMOS. The first image pickup element 24 and the second image pickup element 25 have a function of converting an incident optical image of the object into electric signals. The first image pickup element 24 and the second image pickup element 25 may have sensitivity to the light of same wavelength region, but it is preferred that the first image pickup element 24 have sensitivity to the light of the first wavelength region and the second image pickup element 25 have sensitivity to the light of the second wavelength region. The electric signals obtained by conversion in the first image pickup element 24 and the second image pickup element 25 are inputted to the first input signal processing means 32 and the second input signal processing means 33 of the signal processing unit 30.

The signal processing unit 30 has a function of performing a predetermined signal processing of the signal inputted from the image acquisition unit 20 and outputting the processed signals to the display unit 60. The signal processing unit 30 is provided, for example, inside an electronic control unit (ECU). The reference signal generation means 31 is a circuit having an oscillator that generates a reference signal. The reference signal generated by the reference signal generation means 31 is inputted to the first input signal processing means 32 and the second input signal processing means 33.

The first input signal processing means 32 and the second input signal processing means 33 generate drive signals on the basis of the reference signal generated by the reference signal generation means 31, and drive the first image pickup element 24 and the second image pickup element 25. The first input signal processing means 32 and the second input signal processing means 33 perform a predetermined signal processing of the electric signals inputted from the first image pickup element 24 and the second image pickup element 25, and output the electric signals subjected to the predetermined signal processing to the image synthesis means 35, obstacle recognition means 41, and brightness calculation means 42.

The predetermined signal processing, as referred to herein, is for example a correlated double sampling (CDS) that reduces the signal noise, an auto-gain control (AGC) that normalizes the signal, an analog-digital conversion, or a digital signal processing (color space conversion, edge enhancement correction, gamma correction processing, and the like). The electric signals subjected to the predetermined signal processing are image signals such as composite video or YUV.

The signal subjected to the predetermined processing in the first input signal processing means 32 and outputted from the first input signal processing means 32 is a first image signal, and the signal subjected to the predetermined processing in the second input signal processing means 33 and outputted from the second input signal processing means 33 is a second image signal. An image displayed by the first image signal is a first image, and an image displayed by the second image signal is a second image. Thus, the first image signal is an image signal produced by the light including the visible light region, and the second image signal is an image signal produced by the light including the near-infrared region. Further, the first image is an image displayed by the light including the visible light region, and the second image is an image displayed by the light including the near-infrared region.

The image synthesis means 35 weights the first image signal and the second image signal inputted from the first input signal processing means 32 and the second input signal processing means 33 with a predetermined weight ratio A_{w}. The resultant signals are then summed up to generate an image signal that is outputted to the display unit 60. Thus, the image signal outputted to the display unit 60 is “(first image signal)×(1−A_{w})+(second image signal)×A_{w}”. The predetermined weight A_{w}, may be a fixed value that has been set in advance. Alternatively, the predetermined weight A_{w} may be appropriately determined (A_{w} can be varied correspondingly to the state) on the basis of some or all calculation results of the obstacle recognition means 41 and brightness calculation means 42.

For example, in a case of a high image brightness, the weight A_{w}, of the second image signal (image signal produced by the light including the near-infrared region) is decreased and the weight of the first image signal (image signal produced by the light including the visible light region) is increased. As a result, a focused image can be obtained. Further, increasing the weight of the first image signal (image signal produced by the light including the visible light region) enables the color image display.

The obstacle recognition means 41 recognizes whether an obstacle is present in the image acquired by the image acquisition means 20 on the basis of the first image signal and/or second image signal, and when an obstacle is recognized, the obstacle position is calculated. The obstacle recognition means 41 also calculates the detector reliability that indicates the accuracy of obstacle recognition. The obstacle as referred to herein is, for example, a pedestrian or another vehicle. A case in which the obstacle is a pedestrian will be explained below.

The recognition of a pedestrian as an obstacle, calculation of a position of the pedestrian as an obstacle, and calculation of detection reliability may be implemented, for example, by using a pattern matching method. For example, an image pattern of a pedestrian is recognized in advance and stored in a storage means (memory), and the first image signal and/or second image signal is compared with the pedestrian image pattern that has been stored in advance. As a result, where the two coincide, the presence of a pedestrian is recognized and the position of the pedestrian is calculated. In this case, the detection reliability (for example, from 0 to 1) that indicates the correctness of pedestrian presence recognition is calculated, for example, correspondingly to the degree of matching with the image pattern.

The detection reliability is determined from the processing capacity of the CPU or capacity of the image pattern that has been stored in the storage means (memory). Therefore, high detection reliability is difficult to guarantee for all the situations. Thus, in some cases, even when an object that looks like a pedestrian is recognized, the degree of matching with the image pattern is low and low detection reliability is calculated. Low detection reliability means that the detected object might not be a pedestrian. Conversely, in some cases, the degree of matching with the image pattern is high and high detection reliability is calculated. High detection reliability means a high probability of the detection object being a pedestrian.

As will be described below, the object of calculating the detection reliability with the obstacle recognition means 41 is to use the detection reliability as a piece of information when the necessity of attention drawing display is determined. The recognition results (presence of a pedestrian, position of the pedestrian, and detection reliability) obtained with the obstacle recognition means 41 are inputted to the image synthesis means 35, brightness calculation means 42, and estimated risk degree calculation means 43.

The brightness calculation means 42 calculates a brightness of the image in the position of the pedestrian (brightness of the pedestrian) using the first image signal and/or the second image signal on the basis of the recognition results obtained with the obstacle recognition means 41. The brightness of the pedestrian may be obtained, for example. by calculating the average value of the brightness of pixels corresponding to the position of the pedestrian. Alternatively, a representative point may be selected from among the pixels corresponding to the position of the pedestrian and the brightness of the selected pixel may be determined as the brightness of the pedestrian. The brightness calculation result obtained with the brightness calculation means 42 is inputted to the image synthesis means 35, estimated risk degree calculation means 43, and risk degree calculation means 44.

The estimated risk degree calculation means 43 calculates an estimated risk degree, which is a value obtained by estimating the degree of risk of a collision between the obstacle and the vehicle, on the basis of the recognition results obtained with the obstacle recognition means 41, calculation results obtained with the brightness calculation means 42, and detection results obtained with the below-described sensor unit 50. For example, in a case where the distance between the pedestrian as an obstacle and the vehicle is large, the calculated estimated risk degree is lower than the case where the distance between the pedestrian and the vehicle is small. The calculated result of the estimated risk degree obtained with the estimated risk degree calculation means 43 is inputted to the risk degree calculation means 44.

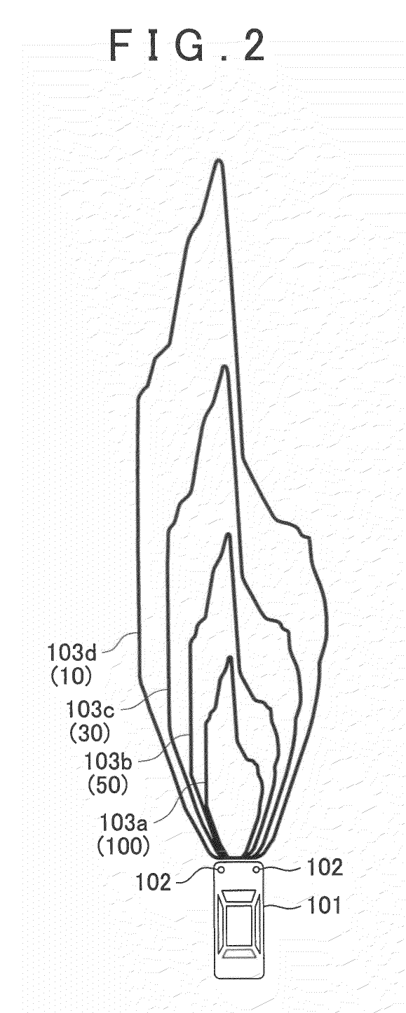

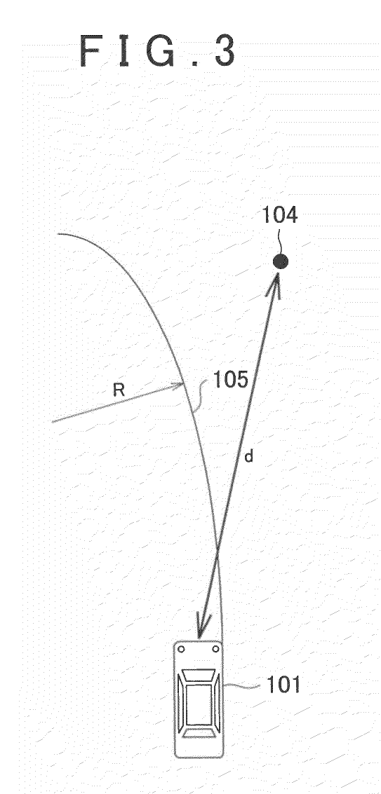

A specific example of calculations performed by the estimated risk degree calculation means 43 will be explained below with reference to FIGS. 2 and 3. FIG. 2 illustrates the estimated risk degree calculation means (variant 1). FIG. 3 illustrates the estimated risk degree calculation means (variant 2). As shown in FIG. 2, a vehicle 101 has headlights 102. Further, FIG. 2 shows equal-brightness curves 103a to 103d in each point of light emitted by the headlights 102 of the vehicle 101. The numbers 100, 50, 30, and 10 in parentheses in the figure are examples of brightness values (unit: lux) of the equal-brightness curves 103a to 103d, respectively. In FIG. 3, an obstacle 104 is shown. FIG. 3 shows a trajectory 105 of a circular turn radius R calculated from the steering angle, wheelbase, vehicle speed, and the like. The estimated risk degree is calculated, for example, from the equal-brightness curves 103a to 103d, distance d to the obstacle 104, relative speed, trajectory of the circular turn radius R, vehicle speed, and the like.

With reference to FIG. 1 again, the risk degree calculation means 44 calculates a risk degree that indicates the degree of risk of a collision between the obstacle and the vehicle on the basis of the calculation result obtained by the brightness calculation means 42 and the calculation result obtained by the estimated risk degree calculation means 43. The risk degree calculated by the risk degree calculation means 44 is inputted to the detection reliability correction value calculation means 45.

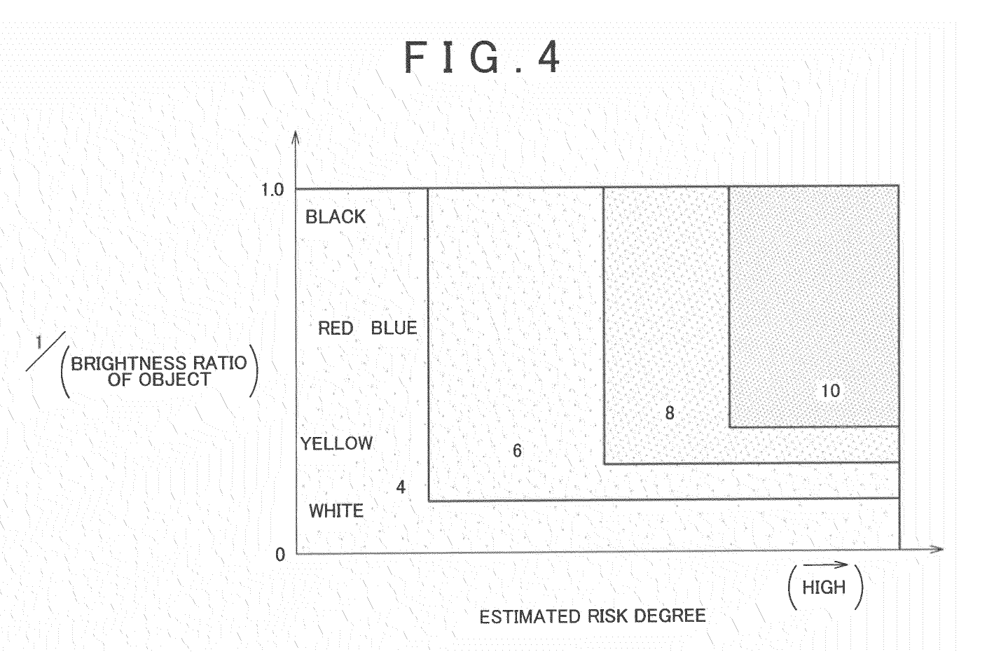

With reference to FIG. 4, a specific example of calculations performed by the risk degree calculation means 44 will be explained below. FIG. 4 illustrates the risk degree calculation means. In FIG. 4 a reciprocal for the brightness ratio of the object that is plotted along the ordinate is obtained from the brightness of the image in the position of a pedestrian that is calculated by the brightness calculation means 42. A region close to 0 corresponds to white color, and as 1.0 is approached, the color changes to yellow, red/blue, and then black. An estimated risk degree calculated by the estimated risk degree calculation means 43 is plotted along the abscissa. The numbers “4, 6, 8, 10” are the risk degrees calculated by the risk degree calculation means 44 on the basis of calculation results obtained with the brightness calculation means 42 and estimation results obtained with the estimated risk degree calculation means 43. In the examples shown in FIG. 4, predetermined regions of equal risk degree are determined from the reciprocal for the brightness ratio of the object plotted on the ordinate and the estimated risk degree plotted on the abscissa, and the risk degrees “4, 6, 8, 10” are assigned to each predetermined region.

For example, even if the estimated risk degree is high, the driver can easily recognize the obstacle, provided that the obstacle is white. Therefore, the risk degree is low and a risk degree of 4 is calculated. Where the obstacle is black, it is difficult for the driver to recognize the obstacle. However, in a case where the estimated risk degree is low, the risk degree is low and a risk degree of 4 is calculated. By contrast, where the estimated risk degree is high and the obstacle is black, the risk degree is high. In this case, a risk degree of 10 is calculated. The calculated risk degree increases as the brightness decreases and the estimated risk degree increases. Thus, the risk degree calculation means 44 calculates the risk degree from two standpoints on the basis of the brightness of the pedestrian that is calculated by the brightness calculation means 42 and the estimated risk degree calculated by the estimated risk degree calculation means 43.

With reference to FIG. 1 again, the detection reliability correction value calculation means 45 calculates the detection reliability correction value by correcting the detection reliability calculated by the obstacle recognition means 41 on the basis of the risk degree calculated by the risk degree calculation means 44. The detection reliability correction value calculated by the detection reliability correction value calculation means 45 is inputted to the attention drawing means 46.

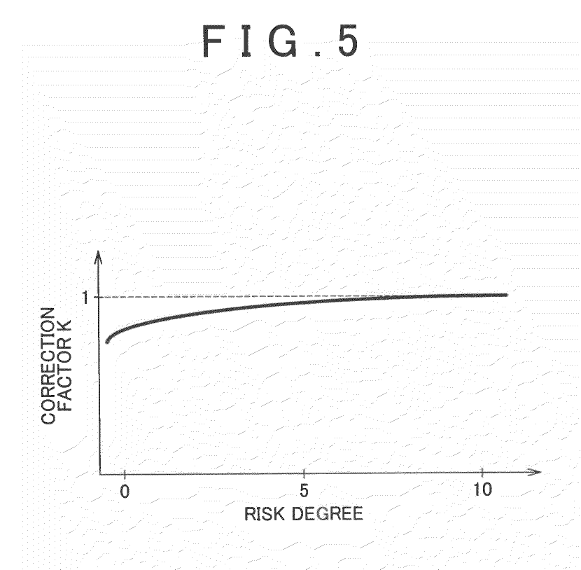

A specific example of calculations performed by the detection reliability correction value calculation means 45 will be explained below with reference to FIG. 5. FIG. 5 illustrates the detection reliability correction value calculation means. In FIG. 5, a correction coefficient K is plotted along the ordinate, and a risk degree is plotted along the abscissa. The risk degree plotted along the abscissa is a value calculated by the risk degree calculation means 44 and corresponds, for example, the risk degrees “4, 6, 8, and 10” shown in FIG. 4. The correction coefficient K is a predetermined value that is stored in the storage means (memory). A curve of the correction coefficient K is determined as any curve in which the correction coefficient K comes closer to 1 as the risk degree rises (approaches 10). The detection reliability correction value calculation means 45 calculates the detection reliability correction value by using the correction coefficient K shown in FIG. 5 to correct the detection reliability calculated by the obstacle recognition means 41. Thus, the detection reliability correction value is obtained by multiplying the detection reliability calculated by the obstacle recognition means 41 by the correction coefficient K.

With reference to FIG. 1 again, where the detection reliability correction value calculated by the detection reliability correction value calculation means 45 is greater than a predetermined display determination threshold, the attention drawing means 46 outputs an attention drawing signal to the display unit 60. This operation has the following meaning.

In principle, the detection reliability correction value has to be calculates high when the risk degree is high. This is because an attention drawing signal has to be outputted to the display unit 60 and the driver's attention to the pedestrian has to be drawn. Therefore, when the risk degree is high as shown by way of example in FIG. 5, the correction coefficient K has a value close to 1.

By contrast, when the risk degree is low, the detection reliability correction value is not necessarily high, and it is rather preferred that the detection reliability correction value be decreased. In the example shown in FIG. 4, when the obstacle is white, the driver can easily recognize the obstacle. Therefore, the risk degree is low and assumes a value of 4. Where the driver's attention is drawn by means of the display unit 60, the driver looks at the display unit 60. However, when no risk is involved, as in the above-described case, it is preferred that the driver look directly at the obstacle rather than on the display unit 60. Accordingly, when the risk degree is low, the correction coefficient K is set a value less than 1. As a result, where the detection reliability correction value is equal to or less than the predetermined display determination threshold, no attention drawing signal is outputted to the display unit 60.

However, in a case where the detection reliability calculated by the obstacle recognition means 41 is low, it is even not clear whether a pedestrian is present. In such a case that the detection reliability calculated by the obstacle recognition means 41 is low, it is also preferred that the driver looks directly at the pedestrian, rather than at the display unit 60 by being drawn his attention. Therefore, the detection reliability correction value is a low value despite a high risk degree (correction coefficient K is close to 1). As a result, where the detection reliability correction value is equal to or less than the predetermined display determination threshold, no attention drawing signal is outputted to the display unit 60.

Thus, it becomes easier to output an attention drawing signal to the display unit 60 as the detection reliability calculated by the obstacle recognition means 41 increases and the risk degree rises (a case in which the probability of danger is high). Thus, in a case where the attention has to be drawn (when a pedestrian is detected with a high probability and a degree of risk is high), the attention can be drawn more reliably. In other eases, the driver is not drawn his attention and does not look at the display unit 60. Therefore, the driver's attention to the zone forward of the vehicle can be maintained.

With reference to FIG. 1 again, the sensor unit 50 has a function of acquiring information of the vehicle and vehicle surroundings. The light control sensor 51 is mounted, for example, on the outside of the vehicle body. The light control sensor 51 detects the brightness of vehicle surroundings and outputs a signal corresponding to the detection result to the estimated risk degree calculation means 43. The vehicle speed sensor 42 is mounted, for example, on the vehicle wheel, detects the rotation speed of the wheel and outputs a signal corresponding to the detection result to the estimated risk degree calculation means 43.

The steering angle sensor 53 is attached, for example, to a steering shaft of the vehicle. The steering angle sensor 53 detects a steering rotation angle and outputs a signal corresponding to the detection result to the estimated risk degree calculation means 43. The distance sensor 54 is for example a milliwave radar that detects the distance between the vehicle and an obstacle. The distance sensor 54 outputs a signal corresponding to the detection result to the estimated risk degree calculation means 43.

The display unit 60 is for example a liquid crystal display. The display unit 60 has a function of displaying as an image only the image signal synthesized by the image synthesis means 35 or the image signal obtained by superimposing an attention drawing signal outputted by the attention drawing means 46 on the image signal synthesized by the image synthesis means 35. The display unit 60 is provided in a position inside the vehicle in which it can be viewed by the driver.

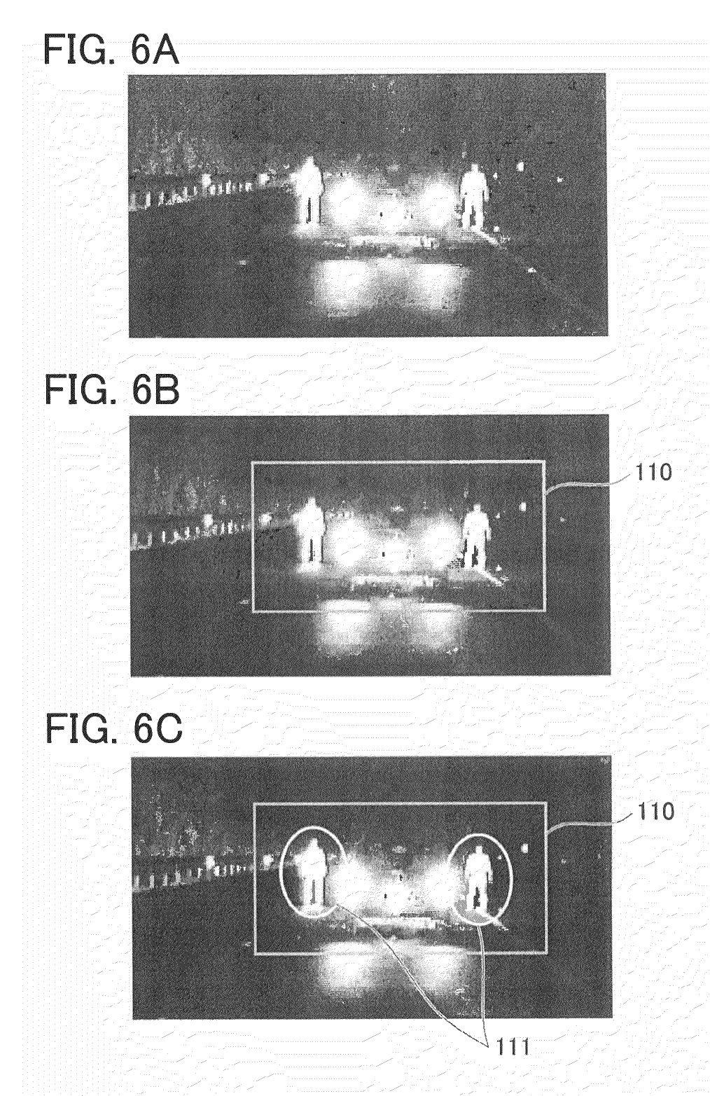

FIGS. 6A to 6C show examples of images displayed by the display unit. FIG. 6A shows an example in which the display unit 60 displays only the image signal synthesized by the image synthesis means 35. FIGS. 6B and 6C show an example in which the display unit 60 displays the image signal obtained by superimposing an attention drawing signal outputted by the attention drawing means 46 on the image signal synthesized by the image synthesis means 35. In FIG. 6B, an attention drawing frame 110 is superimposed as the attention drawing signal for display on a area of the image displayed by the display unit 60 where a pedestrian has been recognized. In FIG. 6C, an attention drawing frame 111 indicating the position of the pedestrian is superimposed and displayed in addition to the attention drawing frame 110 indicating the area where the pedestrian has been recognized, so that the pedestrian can be easily recognized by the driver. The driver's attention can be drawn even more effectively by changing the color of the attention drawing frame 110 or 111 or flashing the frame.

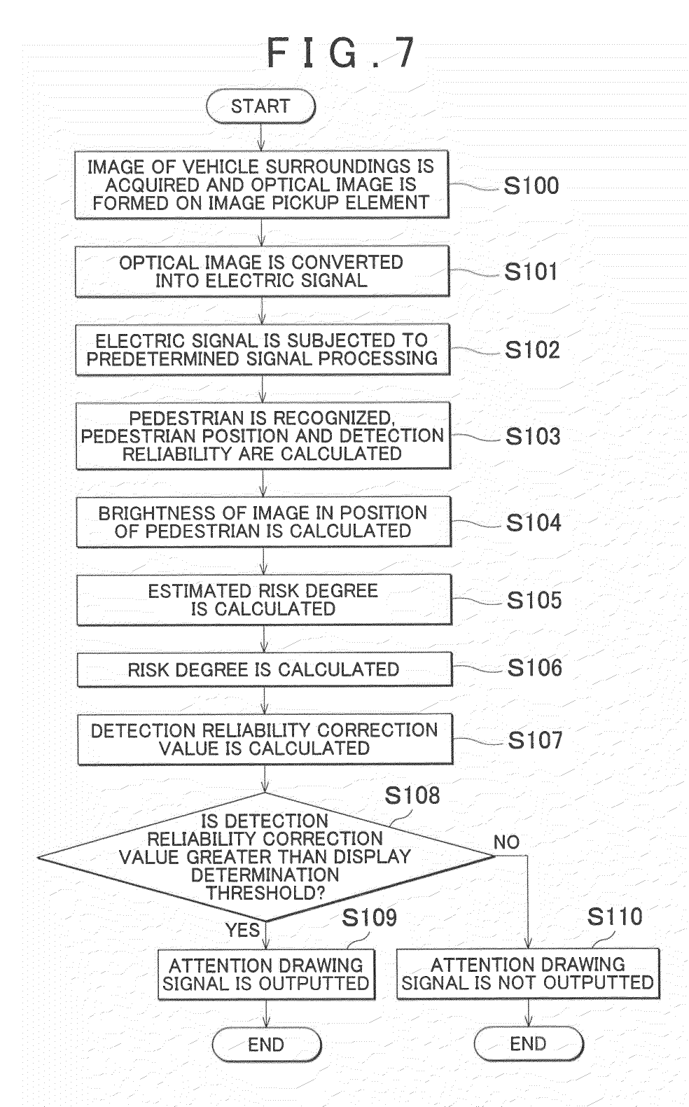

The processing performed by the surroundings monitoring device 10 for a vehicle will be described below in greater detail with reference to FIG. 7. FIG. 7 is an example of the flowchart of operations performed by the surroundings monitoring device for a vehicle of the present embodiment.

In step 100, the image acquisition unit 20 acquires an image of vehicle surroundings and forms an optical image of a first wavelength region on the first image pickup element 24. Further, an optical image of the second wavelength region is formed on the second image pickup element 25 (S100). In this case, the first wavelength region is a wavelength region including a visible light region, and the second wavelength region is a wavelength region including a near-infrared region. Thus, the first wavelength region may be, for example, only the visible light region or a wavelength region obtained by adding the near-infrared region to the visible light region. Further, the second wavelength region may be, for example, only the near-infrared region or a wavelength region obtained by adding an infrared region to the near-infrared region.

In step 101, the first image pickup element 24 converts the optical image of the first wavelength region into an electric signal and outputs the electric signal to the first input signal processing means 32. The second image pickup element 25 converts the optical image of the second wavelength region into an electric signal and outputs the electric signal to the second input signal processing means 33 (S101).

In step 102, the first input signal processing means 32 and the second input signal processing means 33 perform a predetermined signal processing of the inputted electric signals and output the first image signal and the second image signal thus obtained to the image synthesis means 35, obstacle recognition means 41, and brightness calculation means 42 (S102).

In step 103, the obstacle recognition means 41 recognizes whether a pedestrian is present in the image acquired by the image acquisition means 20 on the basis of the first image signal and/or second image signal, and when a pedestrian is recognized, the position of the pedestrian is calculated. The obstacle recognition means 41 also calculates the detection reliability that indicates the accuracy of obstacle recognition (S103). The recognition of the pedestrian, calculation of the position of the pedestrian, and calculation of detection reliability may be implemented, for example, by using a pattern matching method as mentioned hereinabove. The recognition results (presence or absence of the pedestrian, position of the pedestrian, and detection reliability) obtained with the obstacle recognition means 41 are inputted to the image synthesis means 35, brightness calculation means 42, and estimated risk degree calculation means 43.

In step 104, the brightness calculation means 42 calculates a brightness of the image for the position of the pedestrian from the first image signal and/or the second image signal on the basis of the recognition results obtained with the obstacle recognition means 41 (S104). The brightness calculation result obtained with the brightness calculation means 42 is inputted to the image synthesis means 35, estimated risk degree calculation means 43, and risk degree calculation means 44.

In step 105, the estimated risk degree calculation means 43 calculates an estimated risk degree on the basis of the recognition result obtained with the obstacle recognition means 41, calculation result obtained with the brightness calculation means 42, and detection result obtained with the below-described sensor unit 50 (S105). The calculated result of the estimated risk degree obtained with the estimated risk degree calculation means 43 is inputted to the risk degree calculation means 44.

In step 106, the risk degree calculation means 44 calculates a risk degree on the basis of the brightness calculation result obtained by the brightness calculation means 42 and the calculation result obtained by the estimated risk degree calculation means 43 (S106). The risk degree calculated by the risk degree calculation means 44 is inputted to the detection reliability correction value calculation means 45. An example of risk degree calculations is shown in FIG. 4 as described above.

In step 107, the detection reliability correction value calculation means 45 calculates the detection reliability correction value by correcting the detection reliability calculated by the pedestrian recognition means 41 on the basis of the risk degree calculated by the risk degree calculation means 44 (S107). The detection reliability correction value calculated by the detection reliability correction value calculation means 45 is inputted to the attention drawing means 46. An example of calculations of the detection reliability correction value is described above.

In step 108, the attention drawing means 46 determines the necessity of attention drawing display on the basis of the detection reliability correction value calculated by the detection reliability correction value calculation means 45 (S108). The necessity of attention drawing display is determined based on whether the detection reliability correction value calculated by the detection reliability correction value calculation means 45 is greater than a display determination threshold that has been set in advance. In step 108, when the detection reliability correction value is greater than a display determination threshold that has been set in advance, the attention drawing means 46 determines that the attention drawing is necessary (YES in FIG. 7) and the processing flow advances to step 109. In step 109, the attention drawing means 46 outputs an attention drawing signal to the display unit 60 (S109). The attention drawing signal outputted from the attention drawing means 46 is displayed on the display unit 60, for example as shown in FIGS. 6B and 6C described hereinabove, superimposed on the image signal synthesized in the image synthesis means 35. Where no obstacle is present, the attention drawing means 46 stops the output of the attention drawing signal to the display unit 60. As a result, the attention drawing frames 110 and 111, which are the attention drawing signals shown by way of example in FIGS. 6B and 6C above, are deleted.

In step 108, in a case where the detection reliability correction value is equal to or less than the display determination threshold that has been set in advance, the attention drawing means 46 determines that the attention drawing is unnecessary (NO in FIG. 7) and the processing flow advances to step 110. In step 110, the attention drawing means 46 outputs no attention drawing signal to the display unit 60 (S110). As a result, for example as shown in FIG. 6A described above, only the image signal synthesized in the image synthesis means 35 is displayed on the display unit 60.

According to the present embodiment, an obstacle such as a pedestrian is recognized in the image acquired by the image acquisition unit, the position and detection reliability of the obstacle are calculated, and the brightness in the calculated position of the obstacle is calculated. Further, an estimated risk degree, which is a estimate value of the degree of risk of a collision between the obstacle and the vehicle, is calculated on the basis of the vehicle speed and steering angle during the travel. Then, a risk degree that shows a degree of risk of the collision of the obstacle and the vehicle is calculated from two standpoints, namely, on the basis of the calculated brightness and the estimated risk degree. A detection reliability correction value on the basis of the calculated risk degree is then calculated. Where the calculated detection reliability correction value is greater than the predetermined display determination threshold, an attention drawing signal is outputted and the attention drawing signal superimposed on the image acquired by the image acquisition unit is displayed on the display unit(attention drawing is performed). Where the calculated detection reliability correction value is equal to or less than the predetermined display determination threshold, no attention drawing signal is outputted and only the image acquired by the image acquisition unit is displayed on the display unit (attention drawing is not performed).

Thus, whether to output an attention drawing signal to the display unit 60 is determined by correcting the detection reliability on the basis of a risk degree to calculate the detection reliability correction value and then comparing the calculated detection reliability correction value with the display determination threshold. As a result, the attention drawing signal can be easier outputted to the display unit 60 when the detection reliability is high and the risk degree is high (a case in which the probability of danger is high). Therefore, the attention drawing can be performed more reliably. In other cases, no attention drawing is performed and the driver's attention is not drawn to make the driver look at the display unit 60. Therefore, the driver's attention to the zone forward of the vehicle can be maintained. Thus, the driver's attention can be drawn, if necessary, by taking into account the risk degree of a collision between the vehicle and the obstacle and the detection reliability of the obstacle.

The preferred embodiment is described above, but the invention is not limited to the above-described embodiment and may be implemented by variously modifying or changing the above-described embodiment, without departing from the scope of claims.

For example, in the present embodiment, an example is explained in which the light control sensor 51, vehicle speed sensor 52, steering angle sensor 53, and distance sensor 54 are used as the sensor unit 50, but other sensors may be used instead of the above-described sensors or in addition thereto. Examples of the other sensors include an inclination sensor and a Global Positioning system (GPS). By using the inclination sensor or GPS, it is possible to determine the vehicle travel state (whether the location where the vehicle presently travels is a town area or suburbs). Further, in the present embodiment, an example is shown in which the attention drawing signal is outputted on the basis of the detection reliability correction value, but a configuration may be also used in which the attention drawing signal for drawing the driver's attention is outputted on the basis of the risk degree and detection reliability.

What is claimed is:

1. A surroundings monitoring device for a vehicle, comprising:
an image acquisition unit that acquires an image of vehicle surroundings;
an obstacle recognition unit that recognizes an obstacle in the image acquired by the image acquisition unit, calculates a position of the obstacle, and calculates a detection reliability indicating accuracy of recognition of the obstacle;
a risk degree calculation unit that calculates a risk degree that indicates a degree of risk of a collision between the obstacle and the vehicle; and
an attention drawing unit that outputs an attention drawing signal for drawing a driver's attention on the basis of the detection reliability and the risk degree.

2. The surroundings monitoring device for a vehicle according to claim 1, further comprising:
a detection reliability correction value calculation unit that corrects the detection reliability on the basis of the risk degree to calculate a detection reliability correction value, wherein
the attention drawing unit outputs the attention drawing signal in a case where the detection reliability correction value is higher than a threshold.

3. The surroundings monitoring device for a vehicle according to claim 1, further comprising:
a brightness calculation unit that calculates a brightness of the image in a position of the obstacle; and
an estimated risk degree calculation unit that calculates an estimated risk degree of the collision between the obstacle and the vehicle, wherein
the risk degree calculation unit calculates the risk degree on the basis of the brightness and the estimated risk degree.

4. The surroundings monitoring device for a vehicle according to claim 3, wherein the estimated risk degree calculation unit calculates the estimated risk degree on the basis of information including a speed of the vehicle, a steering angle of the vehicle, and a distance between the vehicle and the obstacle.

5. The surroundings monitoring device for a vehicle according to claim 1, wherein the attention drawing signal is a signal for displaying a frame that surrounds an area including the obstacle recognized in the image that has been acquired by the image acquisition unit.

6. The surroundings monitoring device for a vehicle according to claim 1, wherein the attention drawing signal is a signal for displaying a frame that surrounds the obstacle of the image acquired by the image acquisition unit.

7. The surroundings monitoring device for a vehicle according to claim 1, wherein the obstacle is a pedestrian.

8. The surroundings monitoring device for a vehicle according to claim 2, wherein the detection reliability correction value calculation unit calculates the detection reliability correction value by multiplying the detection reliability by a correction coefficient that increases with the increase in the risk degree.

9. The surroundings monitoring device for a vehicle according to claim 3, wherein the risk degree calculation unit calculates a risk degree that increases with the decrease in the brightness and the increase in the estimated risk degree.
